(19) United States
(12) Patent Application Publication
(10) Pub. No.: US 2012/0129566 A1
(43) Pub. Date: May 24, 2012

(54) UPLINK TRANSMISSION POWER CONTROL METHOD AND APPARATUS FOR A DISTRIBUTED ANTENNA MOBILE COMMUNICATION SYSTEM

(75) Inventors: Hyo Jin LEE, Seoul (KR); Youn Sun Kim, Seongnam-si (KR); Joon Young Cho, Suwon-si (KR); Ju Ho Lee, Suwon-si (KR); Jin Kyu Han, Seoul (KR); Young Bum Kim, Seoul (KR)

(73) Assignee: Samsung Electronics Co., Ltd.

(21) Appl. No.: 13/299,927

(22) Filed: Nov. 18, 2011

(30) Foreign Application Priority Data
Nov. 18, 2010 (KR) 10-2010-0114856

(51) Int. Cl. H04W 52/04

(52) U.S. Cl. 455/522

(57) ABSTRACT

An uplink power control method and apparatus of a terminal in a mobile communication system are provided. The method includes receiving, by the terminal, a location parameter corresponding to at least one antenna selected among a plurality of antennas distributed in a service area of a base station, each of the plurality of antennas being connected to the base station; and calculating uplink power based on the location parameter.

### PRIORITY

This application claims priority under 35 U.S.C. §119(a) to Korean Application Serial No. 10-2010-0114856, which was filed in the Korean Intellectual Property Office on Nov. 18, 2010, the entire content of which is incorporated herein by reference.

### BACKGROUND OF THE INVENTION

1. Field of the Invention

The present invention relates generally to mobile communication and, in particular, to an uplink power control method and apparatus for efficiently controlling uplink transmission power in a Distributed Antenna System (DAS)-based mobile communication system including a plurality of base stations.

2. Description of the Related Art

FIG. 1 illustrates the architecture of a conventional mobile communication system including three cells. Each cell is centered around an evolved Node B (eNB) having transmit and receive antennas.

Referring to FIG. 1, the mobile communication system includes a plurality of cells 100, 110, and 120, each centered around an antenna (or antennas) 130, and first and second User Equipments (UEs) 140 and 150. The eNB serves the first and second UEs 140 and 150 within the cells 100, 110, and 120 to provide mobile communication services. Within cell 100, i.e., the service area of the eNB using the antenna(a) 130, the first UE 140 is served at relatively low data rate as compared to the second UE 150, because the first UE 140 farther from the antenna 130 than the second UE 150.

As illustrated in FIG. 1, the formation of the antenna arranged at the center of a cell is referred to as a Central Antenna System (CAS) in mobile communication systems. In CAS, even when an eNB includes multiple antennas, all of these antennas are arranged at the center of the cell to define the service area.

In a mobile communication system implemented with the CAS-based antenna formation, each UE measures an attenuation that a signal experiences to reach the center antenna and performs uplink transmission power based on the measurement result. For a 3^{rd} Generation Partnership Project (3GPP) Long Term Evolution (LTE) system, a UE performs event-triggered power control for Physical Uplink Shared CHannel (PUSCH) as an uplink data channel. Consequently, there is no need to periodically transmit Transmission Power Control (TPC) commands on the PUSCH. In this case, the uplink transmission power P_{PUSCH}(i) in an i^{th} subframe can be expressed using Equation (1).

P_{PUSCH}(i)=min{P_{CMAX},10 log₁₀(M_{PUSCH}(i))+P₀_{_{—}}_{PUSCH}(j)+Δ_{TF}(i)+f(i)+α(j)PL} [dBm] (1)

In Equation (1), P_{CMAX} denotes a maximum transmission power determined depending on a power class of a UE. P_{PUSCH}(i) denotes a PUSCH resource allocated in the i^{th} subframe and is expressed as a number of Resource Blocks (RBs). The uplink transmission power of a UE increases in proportion to the P_{PUSCH}(i). PL denotes a downlink path loss measured by the UE and is calculated using a Reference Signal Received Power (RSRP), which is obtained by measuring the received signal strength of a Cell-specific Reference Signal (CRS) transmitted by the eNB. α(j) denotes a scaling coefficient determined at higher layers in consideration of the path loss inconsistence between uplink and downlink channels.

In an LTE system, a UE can compensate for path loss from the antenna transmitting CRS to the UE for calculating the uplink transmission power.

P_{O}_{_{—}}_{PUSCH} can be expressed as shown in Equation (2).

P_{O}_{_{—}}_{PUSCH}(j)=P_{O}_{_{—}}_{NOMINAL}_{_{—}}_{PUSCH}(j)+P_{O}_{_{—}}_{NOMINAL}_{_{—}}_{PUSCH}(j) (2)

In Equation (2), P_{O}_{_{—}}_{NOMINAL}_{_{—}}_{PUSCH}(j) is a cell-specific parameter that is signaled by a higher layer. P_{O}_{_{—}}_{UE}_{_{—}}_{PUSCH}(j) is a UE-specific parameter that is transmitted through Radio Resource Control (RRC) signaling. Δ_{TF}(i) denotes an Modulation and Coding Scheme (MCS) or Transport Format (TF) compensation parameter, which can be defined as shown Equation (3) below.

$${Δ}_{TF} ( i ) = \{ \begin{matrix}10 & {log}_{10} ( {2}^{MPR ( i ) \cdot {K}_{S}} - 1 ) for {K}_{S} = 1.25 \\ 0 & for {K}_{S} = 0 \end{matrix} \qquad ( 3 )$$

In Equation (3), Kₛ is a cell-specific parameter that is given by RRC signaling. That is, Kₛ can be defined as an indicator for determining the transmission power compensation value depending on frequency efficiency. Further, MPR(i) can be calculated using Equation (4).

$$MPR ( i ) = \frac{{\sum }_{i = 0}^{C - 1} {K}_{r}}{{M}_{PUSCH} ( i ) \cdot {N}_{SC}^{RB} \cdot 2 {N}_{Symb}^{UL}} \qquad ( 4 )$$

In Equation (4), C denotes a number of code blocks in the i^{th} frame, and Kᵣ denotes a length of an r^{th} code block.

$${M}_{PUSCH} ( i ) \cdot {N}_{SC}^{RB} \cdot 2 {N}_{Symb}^{UL}$$

denotes a total number of Resource Elements (REs) in a subframe. That is, the MPR(i) calculated using Equation (4) denotes the number of information bits transmitted per RE. If Kₛ=0, MPR(i)=0 and MCS compensation is not considered. If Kₛ=1.25, only 80%

$$( \frac{1}{{K}_{S}} = 0.8 )$$

of the uplink channel is compensated in the MCS.

The uplink transmission power control instantaneous adaptation is expressed as f (i), as shown in Equation (5).

f(i)=f(i−1)+δ_{PUSCH}(i−K_{PUSCH}) (5)

In Equation (5), δ_{PUSCH} is a UE-specific parameter carried in a Physical Downlink Control CHannel (PDCCH) transmitted from the eNB to the UE and is known as a TPC value. K_{PUSCH} in δ_{PUSCH}(i−K_{PUSCH}) denotes a time offset between receipt of δ_{PUSCH} and applying δ_{PUSCH} in a transmission subframe for a UE. In Downlink Control Information (DCI) format 0 on the PDCCH, the PUSCH dB-accumulated value is [−1, 0, 1, 3]. In DCI format 3/3A on the PDCCH, the δ_{PUSCH} dB-accumulated value is [−1, 1] or [−1, 0, 1, 3].

An absolute value of δ_{PUSCH} can be used, as shown in Equation (6), in place of accumulating δ_{PUSCH}, as shown in Equation (5). In this case, the absolute value of δ_{PUSCH} is [−4, −1, 1, 4] in the DCI format 0 transmitted on the PDCCH.

f(i)=δ_{PUSCH}(i−K_{PUSCH}) (6)

However, the above described uplink power control method of the LTE system can only compensate for path loss from an antenna transmitting CRS used for channel estimation at all the UEs within the cell. Accordingly, a need exists for an improved uplink power control method to evolve the LTE system developed in consideration of CAS system to a distributed antenna system-based LTE system.

### SUMMARY OF THE INVENTION

Accordingly, the present invention is provided to address the above-mentioned problems and/or disadvantages and to offer at least the advantages described below.

An aspect of the present invention is to provide an improved uplink transmission power control method for a DAS-based mobile communication, reducing uplink transmission interference and saving battery consumption of a UE.

In accordance with an aspect of the present invention, an uplink power control method is provided for a terminal in a mobile communication system. The method includes receiving, by the terminal, a location parameter corresponding to at least one antenna selected among a plurality of antennas distributed in a service area of a base station, each of the plurality of antennas being connected to the base station; and calculating uplink power based on the location parameter.

In accordance with another aspect of the present invention, an uplink power control apparatus of a terminal in a mobile communication system is provided, which includes a parameter determiner for receiving a location parameter corresponding to at least one antenna selected among a plurality of antennas distributed in a service area of a base station, each of the plurality of antennas being connected to the base station; and a power controller for calculating uplink power based on the location parameter.

In accordance with another aspect of the present invention, an uplink power control method is provided for a base station in a mobile communication system. The method includes transmitting, by the base station, a location parameter corresponding to at least one antenna selected among a plurality of antennas distributed in a service area of the base station, each of the plurality of antennas being connected to the base station; and receiving, via the at least one antenna, uplink information transmitted by a terminal with uplink power calculated based on the location parameter. The terminal calculates the uplink power by compensating for path loss based on a distance between the at least one antenna and the terminal.

In accordance with another aspect of the present invention, an uplink power control apparatus of a base station in a mobile communication system is provided, which includes a plurality of antennas distributed in a service area of the base station, each of the plurality of antennas being connected to the base station; a transmitter for transmitting a location parameter corresponding to at least one antenna selected among the plurality of antennas; and a receiver for receiving, via the at least one antenna, uplink information transmitted by a terminal with uplink power calculated based on the location parameter. The terminal calculates the uplink power by compensating for path loss based on a distance between the at least one antenna and the terminal.

### BRIEF DESCRIPTION OF THE DRAWINGS

The above and other aspects, advantages, and salient features of certain embodiments of the present invention will become apparent to those skilled in the art from the following detailed description, when taken in conjunction with the accompanying drawings, in which:

FIG. 1 illustrates the architecture of a conventional mobile communication system;

FIG. 2 illustrates a configuration of a mobile communication system according to an embodiment of the present invention;

FIG. 3 is a flowchart illustrating an eNB procedure for transmitting power control parameters in an uplink transmission power control method according to an embodiment of the present invention;

FIG. 4 illustrates uplink transmission power control method according to an embodiment of the present invention;

FIG. 5 is a block diagram illustrating a UE according to an embodiment of the present invention;

FIG. 6 is a flowchart illustrating an uplink power control method of a UE according to an embodiment of the present invention;

FIG. 7 is a flowchart illustrating an uplink power control method of a UE according to an embodiment of the present invention;

FIG. 8 is a flowchart illustrating an uplink power control method of a UE according to an embodiment of the present invention; and

FIG. 9 is a flowchart illustrating an uplink power control method according to an embodiment of the present invention.

### DETAILED DESCRIPTION OF EMBODIMENTS OF THE INVENTION

Various embodiments of the present invention are described in detail below with reference to the accompanying drawings. Detailed descriptions of well-known functions and structures incorporated herein may be omitted to avoid obscuring the subject matter of the present invention. Further, the following terms are defined in consideration of the functionality in the present invention, and may vary according to the intention of a user or an operator, usage, etc. Therefore, the definition should be made on the basis of the overall content of the present specification.

Although detailed descriptions of embodiments of the present invention will be given herein with reference to an OFDM-based mobile communication system, particularly, the 3GPP Evolved Universal Terrestrial Radio Access (EUTRA) standard, by way of example, it will be understood by those skilled in the art that the present invention is also applicable to other communication systems having similar technical backgrounds and channel formats, with slight modification, without departing from the spirit and scope of the present invention.

A DAS is built with the antennas distributed within a cell, i.e., a service area of an eNB, in order to provide improved mobile communication service, as compared to a CAS.

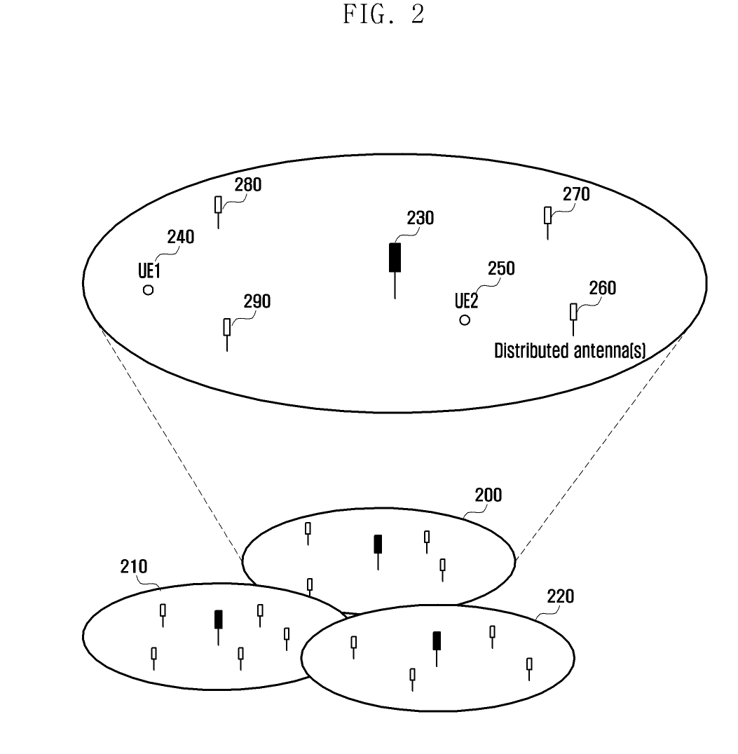

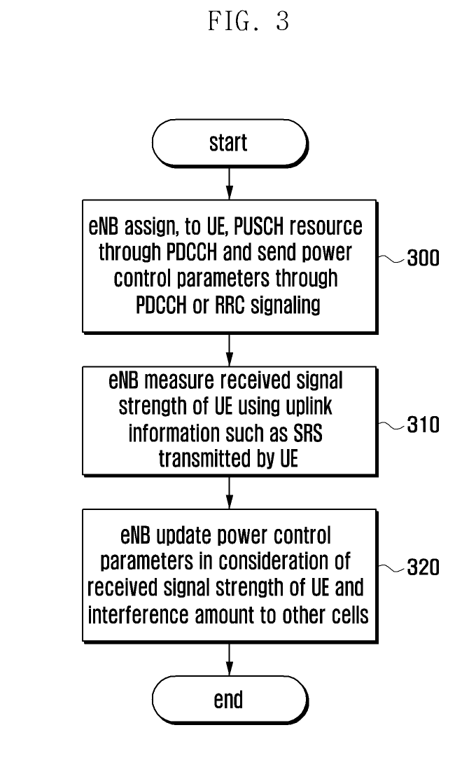

FIG. 2 illustrates a mobile communication system according to an embodiment of the present invention. As an example, the mobile communication system in FIG. 3 includes three cells, each cell being centered around an eNB that is provided with a plurality of antennas distributed throughout the service area of the cell.

Referring to FIG. 2, the mobile communication system includes a plurality of cells 200, 210, and 220, and each cell incudes a central antenna 230 arranged at a center of the cell, and a plurality of distributed antennas 260, 270, 280, and 290 distributed throughout the service area of the cell.

Additionally, cell 200 includes a first UE 240 and a second UE 250. Each of the first and second UEs 240 and 250 is served by the eNB through at least one of the central antenna 230 and the distributed antennas 260, 270, 280, and 290.

For example, the first UE 240 receives a mobile communication service provided by the eNB through the distributed antennas 280 and 290, which are located closest to the first UE 240, and the second UE 250 receives a mobile communication service provided by the eNB through the central antenna 230, which is located closest to the second UE 250.

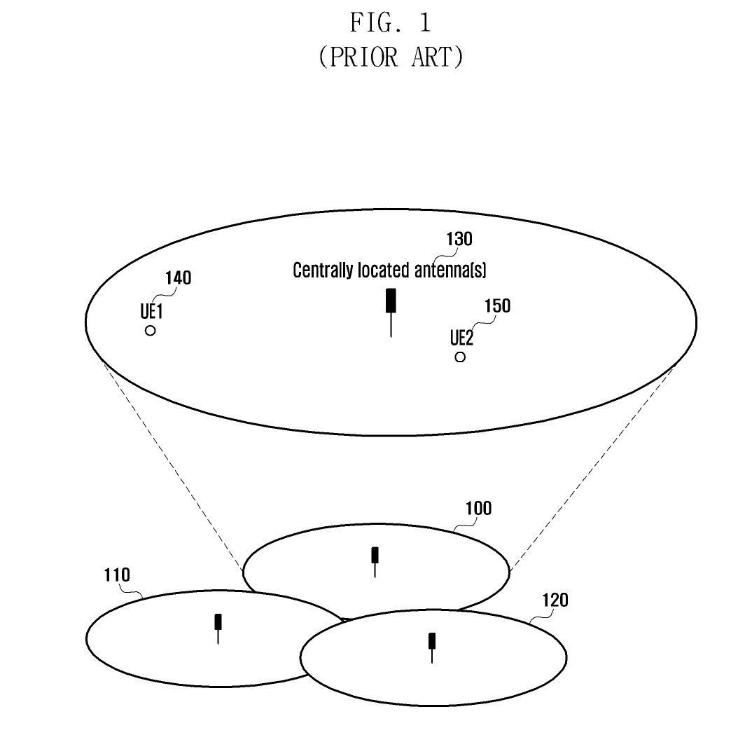

As illustrated in FIG. 1, if the mobile communication system was a CAS, the first UE 240 would be served at relatively low data rate because it is located far from the central antenna 230. However, in the DAS-based mobile communication system illustrated in FIG. 2, the first UE 240 can be served at relatively high data rate using the distributed antennas 280 and 290, which are located close to the first UE 240.

Using the power control method of the LTE system, a UE can only compensate for the path loss from the antenna transmitting CRS for uplink transmission power to the UE. That is, an LTE UE performing uplink transmission using specific distributed antennas cannot correctly compensate for path loss for the distributed antennas in the DAS-based system, causing unnecessary power consumption and uplink interference.

As described above, the uplink power control method of the LTE system compensates for path loss related to an antenna transmitting CRS used for channel estimation. Accordingly, the uplink power control method developed in consideration of a CAS-based system should be modified for a DAS-based system.

In accordance with an embodiment of the present invention, an uplink power transmission power control method is provided, which is capable of compensating for the uplink path-loss in association with the UE performing uplink transmission using distributed antennas in the DAS-based communication system, thereby reducing uplink interference and unnecessary battery consumption.

FIG. 3 is a flowchart illustrating an eNB procedure for transmitting power control parameter in an uplink transmission power control method according to an embodiment of the present invention.

Referring to FIG. 3, in step 300, an eNB assigns a PUSCH resource to a UE through a PDCCH and transmits parameters related to power control through the PDCCH or RRC signaling. That is, the eNB determines whether to transmit the power control parameters through RRC signaling on the Physical Downlink Shared CHannel (PDSCH) or through the PDCCH. If the eNB determines to use the PDCCH (e.g., δ_{PUSCH}), the eNB transmits the power control parameters to the UE through the PDCCH. Otherwise, if the eNB determines to use RRC signaling (e.g., Kₛ), the eNB transmits the power control parameters to the UE through RRC signaling. Here, the power control parameters are the parameters for use in the uplink power control of the UE.

In step 310, the eNB measures the Signal to Interference plus Noise Ratio (SINR) using the uplink information, such as a Sounding Reference Signal (SRS) transmitted by the UE. In step 320, the eNB updates the power control parameters based on the received signal strength of the uplink information and the interference amount of the uplink information to neighbor cells, and then ends the power control parameter transmission procedure. The updated power control parameters are transmitted through a channel determined for the next power control parameter procedure.

Although not illustrated, in addition to the plurality of antennas, the eNB includes a receiver, a power measurer, a parameter determiner, a transmitter, and a controller. The receiver receives the uplink information transmitted by the UEs within the services area through the plurality of antennas. The power measurer measures the received signal strengths of the uplink information per UE. The parameter determiner determines the power control parameter based on the received signal strength per UE. For example, the parameter determiner can calculate path loss based on a distance between the UE and the antenna to be used for communication with the UE, and can use the path loss as the power control parameter. The transmitter transmits the power control parameters for each UE. The controller controls to transmit the reference signal at a predetermined transmission power level, such that the UE refers to the signal to measure the channel state.

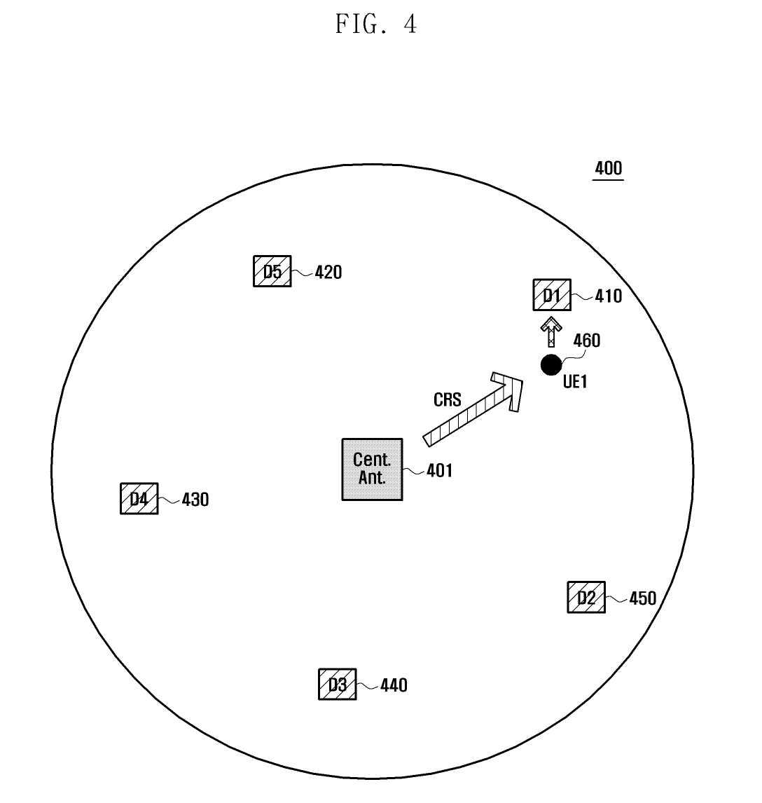

FIG. 4 illustrates an uplink transmission power control method according to an embodiment of the present invention.

Referring to FIG. 4, a DAS-enabled cell 400 is centered around a central antenna 401 of an eNB and includes a plurality of antennas 410, 420, 430, 440, and 450 that are distributed throughout the service area of the eNB. A UE 460 can transmit uplink information to the eNB through at least one of the central antenna 401 and distributed antennas 410, 420, 430, 440, and 450. Because CRS should be received even by an LTE UE that does not, use the distributed antennas 410, 420, 430, 440, and 450 within the cell 400, the eNB transmits CRS through the central antenna 401 covering the entire service area of the cell 400.

If the UE 460 calculates uplink power using the power control algorithm of the conventional LTE system, as described above, only path loss between the central antenna 401 and the UE 460 is taken into account, without consideration of the path loss between the distributed antenna 410 and the UE 460. This causes excessive power consumption for transmission of uplink information through the distributed antenna 410. Accordingly, there is a need for a new uplink power control method that supports uplink transmission for supporting DAS-based service in the LTE system.

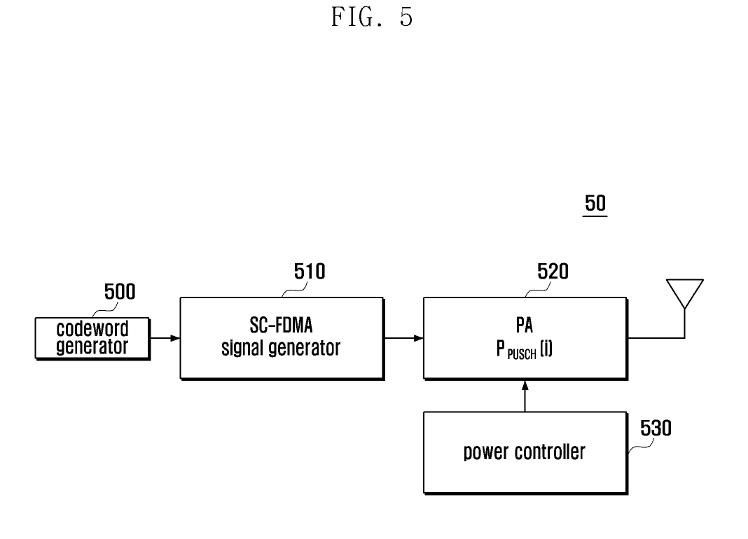

FIG. 5 is a block diagram illustrating a UE according to an embodiment of the present invention.

Referring to FIG. 5, the UE 50 includes a codeword generator 500, a Single Carrier Frequency Division Multiple Access (SC-FDMA) signal generator 510, a power amplifier (PA) 520, and a power controller 530. The codeword generator 500 generates a codeword. The SC-FDMA signal generator 510 performs Discrete Fourier Transform (DFT) and Inverse DFT on the codeword in sequence to generate an SC-FDMA signal. The PA 520 configures transmission power under the control of the power controller 530 to transmit the codeword to the eNB through a transmission antenna. The power controller 530 controls the PA 520 to be set with the uplink power in consideration of the power control parameters and PUSCH scheduling information received from the eNB. The power controller 530 includes a parameter determiner to determine the power control parameter for use in uplink power calculation.

The parameter determiner of the power controller 530 receives the location parameter corresponding to at least one antenna for use in communication with the eNB, among a plurality antennas distributed in the service area of the eNB. The parameter determiner determines the path loss between the communication antenna and the UE 50, based on the location parameter.

The location parameter can be used to determine a Channel Station Information Reference Signal (CSI-RS) and transmission power of the CSI-RS, and the parameter determiner measures the received signal power of the CSI-RS and calculates the path loss by comparing the transmission and reception powers of the CSI-RS with each other. The location parameter can be an instantaneous adaptation value, and the parameter determiner can interpret the instantaneous adaptation value according to a predetermined value.

The power controller 530 calculates uplink power with the compensation of the path loss. When the central antenna is selected for communication, the power controller 530 calculates the uplink power with a predetermined first instantaneous adaptation value. However, when a distributed antenna is selected for communication, the power controller 530 calculates the uplink power with a predetermined second instantaneous adaptation value, which differs from the first instantaneous adaptation value. The power controller 530 configures the PA 520 with the uplink power, and the PA 520 transmits the uplink information to the eNB through the communication antenna at the uplink power level.

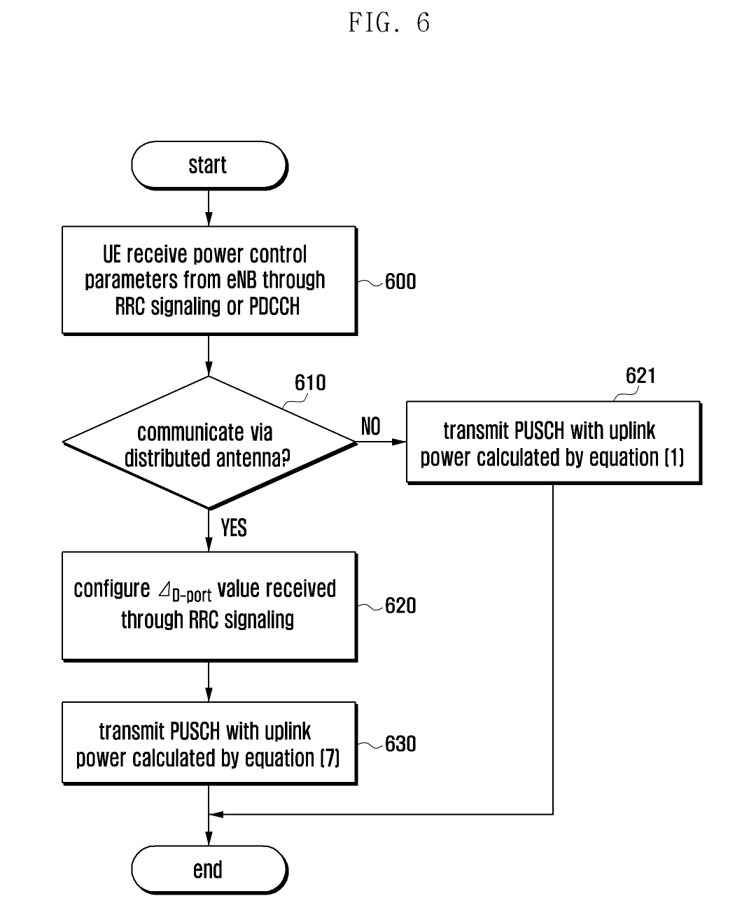

FIG. 6 is a flowchart illustrating an uplink power control method of a UE according to an embodiment of the present invention.

Referring to FIG. 6, in step 600, the UE 50 receives power control parameters for controlling uplink power of the UE 50 from an eNB. In order to define the power control parameters, a power control formula for DAS-based service is defined. The power control formula for supporting DAS-based communication service is defined to compensate for path loss between one of the distributed antennas in the service area for communication with the eNB and the UE 50. For example, the power control formula for DAS-based service can be defined as shown in Equation (7).

P_{PUSCH}(i)=min{P_{CMAX},10 log₁₀(M_{PUSCH}(i))+P₀_{_{—}}_{PUSCH}(j)+Δ_{TF}(i)+f(i)+α(j)PL_{CRS}+Δ_{D-port}} [dBm] (7)

In Equation (7), P_{CMAX}, M_{PUSCH}(i), P_{O}_{_{—}}_{PUSCH}(j), α(j), and f(i) are the same as defined for Equation (1), and are received from the eNB, as described above. PL_{CRS} is the same as PL in Equation (1), and denotes the path loss between the central antenna and the UE 50. Again, PL_{CRS} is calculated based on the received signal strength of CRS transmitted through the central antenna of the cell.

Δ_{D-port} is a parameter newly introduced for DAS-based service, which is determined in consideration of a distance between the distributed antenna selected by the eNB for communication with the UE 50 and the UE 50, and is transmitted to the UE 50 through RRC signaling. More specifically, Δ_{D-port} is determined by the eNB, using locations of the distributed antennas, and is transmitted to the UE with the information of the distributed antenna selected for use in communication with the UE. Δ_{D-port} also can be determined by the eNB based on path loss between a distributed antenna and the UE that are measured using SRS and then transmitted to the UE 50.

In step 610, the UE 50 determines whether the antenna used in communicating with the eNB is a distributed antenna. Basically, the UE 50 determines whether a distributed antenna is used, based on whether Δ_{D-port} is received from the eNB. That is, if Δ_{D-port} is received from the eNB, the UE 50 determines that a distributed antenna is involved in the communication with the eNB. Otherwise, if Δ_{D-port} is not received from the eNB, the UE 50 determines that no distributed antenna is involved in the communication with the eNB.

If it is determined that a distributed antenna is used for communication with the eNB in step 610, the UE 50 configures Equation (7) with Δ_{D-port} in step 620. In step 630, the UE 50 sets other parameters, calculates uplink transmission power using Equation (7), and transmits the PUSCH with the calculated uplink transmission power.

However, if it is determined that only the central antenna is used for communication with the eNB in step 610, the UE 50 calculates uplink transmission power using Equation (1), without using Δ_{D-port}, and transmits the PUSCH with the calculated transmission power in step 621. Here, the UE 50 can set Δ_{D-port} to 0 in Equation (7) to calculate the uplink power for the PUSCH transmission.

The eNB transmits the power control parameters to the UE in step 600, as described with reference to FIG. 3, and the power control parameters are used in Equation (7) for calculating the uplink transmission power, when a distributed antenna is used for communication between the eNB and UE 50.

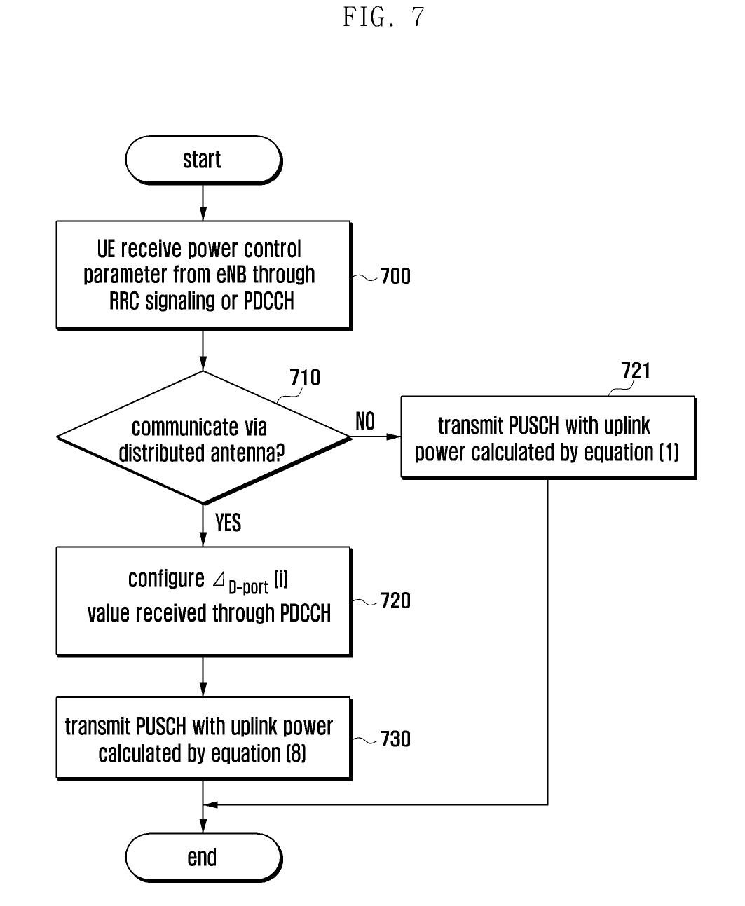

FIG. 7 is a flowchart illustrating an uplink power control method of a UE according to another embodiment of the present invention. Unlink the method in FIG. 6, in which the UE 50 receives the power control parameter, Δ_{D-port}, transmitted by the eNB for compensating for uplink path loss from the UE 50 to a distributed antenna, in FIG. 7, the UE 50 receives the power control parameter for compensating for path loss through dynamic signaling on a PDCCH as a downlink control channel.

Referring to FIG. 7, the UE 50 receives power control parameters through RRC signaling or the PDCCH in step 700. The power control parameter for compensating for path loss between a distributed antenna and the UE 50 is transmitted from the eNB to the UE 50 through dynamic signaling on PDCCH. Accordingly, a power control formula for supporting DAS-based service can be defined as shown in Equation (8).

P_{PUSCH}(i)=min{P_{CMAX},10 log₁₀(M_{PUSCH}(i))+P₀_{_{—}}_{PUSCH}(j)+Δ_{TF}(i)+f(i)+α(j)PL_{CRS}+Δ_{D-port}(i)} [dBm] (8)

In Equation (8), P_{CMAX}, M_{PUSCH}(i), P_{O}_{_{—}}_{PUSCH}(j), α(j), and f(i) are the same as defined in Equation (1), and are received from the eNB, as described above. PL_{CRS} is the same as PL in Equation (1) and denotes the path loss between the central antenna and the UE 50. Again, PL_{CRS} is calculated based on a received signal strength of CRS transmitted through the central antenna of the cell.

Δ_{D-port} (i) is a parameter newly introduced for a DAS-based service, which is determined based on a distance between the distributed antenna selected by the eNB for communication with the UE 50 and the UE 50. Δ_{D-port} (i) is transmitted to the UE 50 through dynamic signaling on the PDCCH. Specifically, Δ_{D-port}(i) is determined by the eNB, based on the path loss between the distributed antenna and UE 50, and is transmitted to the UE 50.

To support the DAS-based service, some bits for Δ_{D-port}(i) can be added in a PDCCH of an LTE or LTE-Advanced (LTE-A) system or some bits of the uplink grant of the LTE or LTE-A system can be reused. For example, a frequency hopping bit or a padding bit of the uplink grant of the LTE system can be reused for Δ_{D-port}(i) in the DAS-based service. When the UE 50 supports the use of a distributed antenna with f(i) as a TPC value composed of bits, Δ_{D-port}(i), which is newly defined in Equation (8) can be expressed to use f(i) composed of more than 2 bits.

In step 710, the UE 50 determines whether the antenna used in the communication with the eNB is a distributed antenna. If the UE 50 determines that a distributed antenna is used for communication with the eNB in step 710, the UE 50 configures Equation (8) with Δ_{D-port}(i) in step 720. In step 730, the UE 50 sets other parameters, calculates uplink transmission power using Equation (8), and transmits the PUSCH with the calculated uplink transmission power.

If is the UE 50 determines that the central antenna is used for communication with the eNB in step 710, the UE 50 calculates uplink transmission power using Equation (1), without use of Δ_{D-port}(i), and transmits the PUSCH with the calculated transmission power in step 721. Here, the UE 50 can set Δ_{S-port}(i) to 0 in Equation (8) to calculate the uplink power for the PUSCH transmission.

As described above, Δ_{D-port}(i) can be expressed with f(i) composed of more than 2 bits. In this case, step 720 can be modified to a step for checking the bits added for power control in the DAS-based service of the LTE system.

The eNB transmits the power control parameters to the UE in step 700, as described with reference to FIG. 3, and the power control parameters are used in Equation (8) for calculating the uplink transmission power, when a distributed antenna is used for communication between the eNB and UE 50.

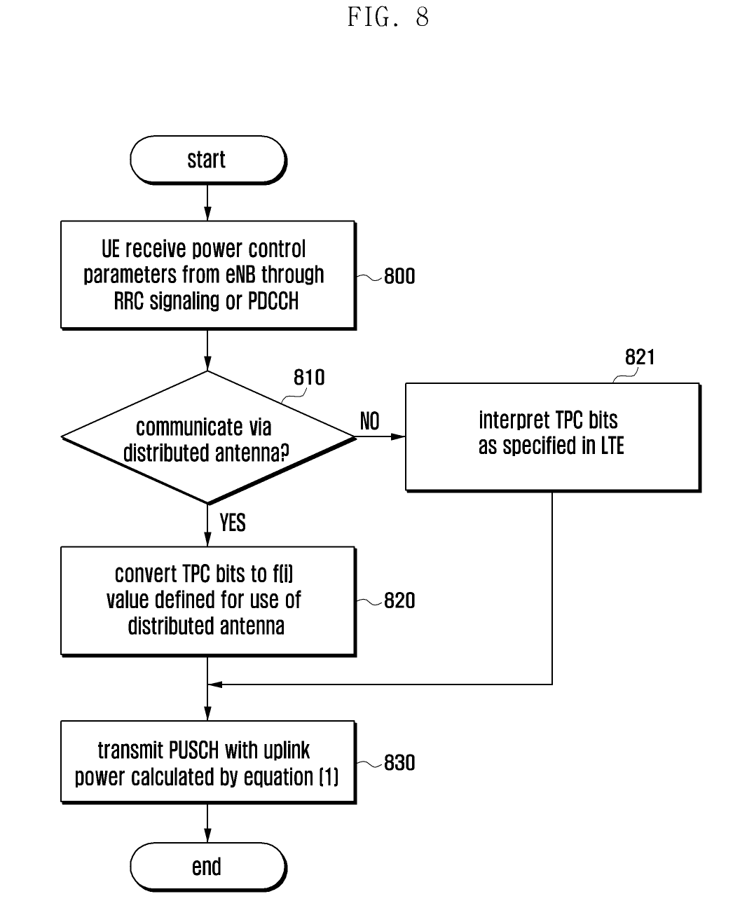

FIG. 8 is a flowchart illustrating an uplink power control method of a UE according to an embodiment of the present invention. The method illustrated in FIG. 8 is the same as that illustrated in FIG. 7, in that the power control parameter for compensating for path loss is transmitted through dynamic signaling on PDCCH as downlink control channel. However, in the method illustrated in FIG. 8, the TPC part of Equation (1) is interpreted in different way when a distributed antenna is used, other than introducing additional bits for the purpose of path loss compensation.

Referring to FIG. 8, the UE 50 receives power control parameters through RRC signaling or the PDCCH in step 800. In step 810, the UE 50 determines whether the antenna used in the communication with the eNB is a distributed antenna. If it is determined that a distributed antenna is used for communication with the eNB in step 810, in step 820, the UE 50 interprets the TPC bits as f(i) of Equation (1), defined for the situation using a distributed antenna.

However, if it is determined that the central antenna is used for communicating with the eNB in step 810, the UE 50 interprets the TPC bits as specified in LTE standard in step 821. In step 830, the UE 50 configures the uplink transmission power using Equation (1) and performs PUSCH transmission with the uplink transmission power.

As described above, the accumulation value of TPC bits in a DCI format transmitted on a PDCCH in the LTE system is [−1, 0, 1, 3], and the accumulation values of TPC bits in a DCI format 3/3A transmitted on the PDCCH are [−, 1] and [−1, 0, 1, 3]. The absolute value of f(i) by TPC bits in a DCI format 0 transmitted on the PDCCH is [−4, −1, 1, and 4]. When communicating with the eNB through a distributed antenna, the UE 50 can perform transmission with relatively low uplink transmission power as compared to using the central antenna. Accordingly, when communicating with the eNB through a distributed antenna, the TPC bits can be interpreted as more negative values of their original values for use the LTE system.

The eNB transmits the power control parameters to the UE 50 in step 800, as described with reference to FIG. 3, and the power control parameters are used in Equation (8) for calculating the uplink transmission power, when a distributed antenna is used for communication between the eNB and UE 50.

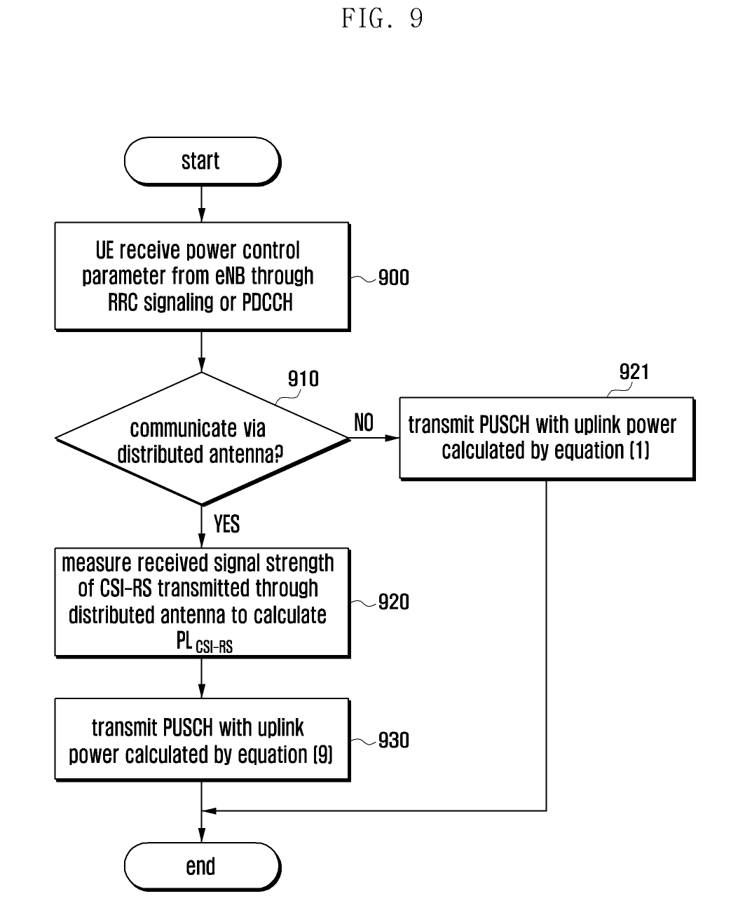

FIG. 9 is a flowchart illustrating an uplink power control method of a UE according to an embodiment of the present invention. Unlike the methods illustrated in FIGS. 6-8, in the method illustrated in FIG. 9, a new formula is provided for calculating an uplink transmission power based on path loss between the distributed antenna and the UE 50.

Referring to FIG. 9, the UE 50 receives power control parameters through RRC signaling or PDCCH in step 900. In order to define the power control parameters, a power control formula for DAS-based service is defined.

The power control formula for supporting DAS-based communication service compensates for path loss between at least one of the antennas distributed in the service area for communication with the eNB and the UE 50 by measuring the received signal strength of a CSI-RS. The power control formula for DAS-based service can be defined as shown in Equation (9).

P_{PUSCH}(i)=min{P_{CMAX},10 log₁₀(M_{PUSCH}(i)+P₀_{_{—}}_{PUSCH}(j)+Δ_{TF}(i)+f(i)+α(j)PL_{CSI-RS}} [dBm] (9)

In Equation (9), P_{CMAX}, M_{PUSCH}(i), P_{O}_{_{—}}_{PUSCH}(j), α(j), and f(i) are that same as defined in Equation (1), and are received from the eNB, as described above. PL_{CSI-RS} is a parameter that is newly introduced for supporting DAS-based service and is calculated based on a received signal strength transmitted by the eNB through distributed antennas. In this case, the eNB transmits a signal for identifying the distributed antenna through which the CSI-RS is transmitted, such that the UE 50 can use the CSI-RS transmitted through the correct distributed antenna to calculate the uplink transmission power. That is, the eNB notifies the UE 50 of the CSI-RS and of the transmission power of the CSI-RS, rather than notifying the UE of the distributed antenna directly. Using the difference between the transmission power of the CSI-RS and the received signal strength of the CSI-RS that is measured by the UE 50, the UE 50 calculates PL_{CSI-RS}, and compensates for the uplink transmission power for the path loss between the distributed antenna and the UE 50 based on PL_{CSI-RS}.

In step 910, the UE 50 determines whether the antenna used in the communication with the eNB is a distributed antenna. If it is determined that a distributed antenna is used for communication with the eNB in step 910, the UE 50 measures the received signal strength of CSI-RS transmitted through the distributed antenna and calculates PL_{CSI-RS} using the difference between the CSI-RS transmission power provided by the eNB and the received signal strength of the CSI-RS in step 920. In step 930, the UE 50 sets other parameters, calculates uplink transmission power using Equation (9), and transmits the PUSCH with the calculated uplink transmission power.

If it is determined that the central antenna is used for communication with the eNB in step 910, the UE 50 calculates uplink transmission power using Equation (1) and transmits the PUSCH with the calculated transmission power in step 921.

The eNB transmits the power control parameters to the UE 50 in step 900, as described with reference to FIG. 3, and the power control parameters are used in Equation (9) for calculating the uplink transmission power, when a distributed antenna is used for communication between the eNB and UE 50.

As described above, the uplink power control method and apparatus for an LTE system according to the embodiments of present invention are capable of supporting DAS-based service, thereby reducing interference between uplink transmissions and power consumption of UE.

Although certain embodiments of the present invention have been described in detail hereinabove, it should be clearly understood that many variations and/or modifications of the basic inventive concepts herein taught, which may appear to those skilled in the present art, will still fall within the spirit and scope of the present invention, as defined in the appended claims and their equivalents.

What is claimed is:

1. An uplink power control method of a terminal in a mobile communication system, the method comprising:
receiving, by the terminal, a location parameter corresponding to at least one antenna selected among a plurality of antennas distributed in a service area of a base station, each of the plurality of antennas being connected to the base station; and
calculating uplink power based on the location parameter.

2. The method of claim 1, further comprising compensating for a path loss, based on a distance between the at least one antenna and the terminal.

3. The method of claim 2, wherein the location parameter determines a Channel State Information Reference Signal (CSI-RS) transmitted through the at least one antenna and a transmission power of the CSI-RS, and
wherein calculating the uplink power comprises:
measuring a received signal strength of the CSI-RS; and
calculating the path loss by comparing the transmission power of the CSI-RS and the received signal strength of the CSI-RS.

4. The method of claim 1, wherein the location parameter includes a Transmission Power Control (TPC) value, and
wherein calculating the uplink power comprises interpreting the TPC value according to a predetermined rule.

5. The method of claim 1, wherein the location parameter is received through one of Radio Resource Control (RRC) signaling and dynamic signaling on a data channel.

6. The method of claim 1, further comprising transmitting uplink information to the base station via the at least one antenna with the uplink power.

7. An uplink power control apparatus of a terminal in a mobile communication system, the apparatus comprising:
a parameter determiner for receiving a location parameter corresponding to at least one antenna selected among a plurality of antennas distributed in a service area of a base station, each of the plurality of antennas being connected to the base station; and
a power controller for calculating uplink power based on the location parameter.

8. The apparatus of claim 7, wherein the power controller compensates for path loss based on a distance between the at least one antenna and the terminal.

9. The apparatus of claim 8, wherein the location parameter determines a Channel State Information Reference Signal (CSI-RS) transmitted through the at least one antenna and a transmission power of the CSI-RS, and
wherein the power controller measures a received signal strength of the CSI-RS and calculates the path loss by comparing the transmission power of the CSI-RS and the received signal strength of the CSI-RS.

10. The apparatus of claim 7, wherein the location parameter comprises a Transmission Power Control (TPC) value, and
wherein the power controller interprets the TPC value according to a predetermined rule.

11. The apparatus of claim 7, further comprising a power amplifier for transmitting uplink information to the base station via the at least one antenna with the uplink power.

12. An uplink power control method of a base station in a mobile communication system, the method comprising:
transmitting, by the base station, a location parameter corresponding to at least one antenna selected among a plurality of antennas distributed in a service area of the base station, each of the plurality of antennas being connected to the base station; and
receiving, via the at least one antenna, uplink information transmitted by a terminal with uplink power calculated based on the location parameter,
wherein the terminal calculates the uplink power by compensating for path loss based on a distance between the at least one antenna and the terminal.

13. The method of claim 12, wherein the location parameter determines a Channel State Information Reference Signal (CSI-RS) transmitted through the at least one antenna and a transmission power of the CSI-RS, and
wherein the terminal measures a received signal strength of the CSI-RS and calculates the path loss by comparing the transmission power of the CSI-RS and the received signal strength of the CSI-RS.

14. An uplink power control apparatus of a base station in a mobile communication system, the apparatus comprising:
a plurality of antennas distributed in a service area of the base station, each of the plurality of antennas being connected to the base station;
a transmitter for transmitting a location parameter corresponding to at least one antenna selected among the plurality of antennas; and
a receiver for receiving, via the at least one antenna, uplink information transmitted by a terminal with uplink power calculated based on the location parameter,
wherein the terminal calculates the uplink power by compensating for path loss based on a distance between the at least one antenna and the terminal.

15. The apparatus of claim 14, wherein the parameter determines a Channel State Information Reference Signal (CSI-RS) transmitted through the at least one antenna and a transmission power of the CSI-RS, and
wherein the terminal measures a received signal strength of the CSI-RS and calculates the path loss by comparing the transmission power of the CSI-RS and the received signal strength of the CSI-RS.
